(19) United States
(12) Patent Application Publication
(10) Pub. No.: US 2025/0371174 A1
(43) Pub. Date: Dec. 4, 2025

(54) MEMORY PAGE MANAGEMENT METHODS AND APPARATUSES

(71) Applicant: Alipay (Hangzhou) Information Technology Co., Ltd., Hangzhou (CN)

(72) Inventors: Shuang LIU, Hangzhou (CN); Zhou CHEN, Hangzhou (CN); Shoumeng YAN, Hangzhou (CN)

(73) Assignee: Alipay (Hangzhou) Information Technology Co., Ltd., Hangzhou (CN)

(21) Appl. No.: 19/299,031

(22) Filed: Aug. 13, 2025

Related U.S. Application Data
(63) Continuation of application No. PCT/CN2024/085826, filed on Apr. 3, 2024.

(30) Foreign Application Priority Data
Apr. 6, 2023 (CN) 202310377569.9

(51) Int. Cl. G06F 21/60

(52) U.S. Cl. CPC G06F 21/602

(57) ABSTRACT

Memory page management is described. A to-be-swapped-out first memory page is determined from a secure memory area of a memory. A second memory page is determined from the memory, where the second memory page is located outside the secure memory area. Based on a physical address of the second memory page by using a memory encryption engine (MEE) of a processor, target data stored on the to-be-swapped-out first memory page is encrypted to obtain a target ciphertext. The target ciphertext is written on the second memory page. The to-be-swapped-out first memory page is released and the second memory page is locked, so that the target data is allowed to swap only from the second memory page into the secure memory area.

### CROSS-REFERENCE TO RELATED APPLICATIONS

This application is a continuation of PCT Application No. PCT/CN2024/085826, filed on Apr. 3, 2024, which claims priority to Chinese Patent Application No. 202310377569.9, filed on Apr. 6, 2023, and each application is hereby incorporated by reference in its entirety.

### TECHNICAL FIELD

One or more embodiments of this specification relate to the computer field, and in particular, to memory page management methods and apparatuses.

### BACKGROUND

In hardware-based trusted execution environment (TEE) solutions, a secure memory area belonging to a TEE generally needs to be reserved in a memory of a computing device. In a running process of the computing device, a memory paging mechanism may be enabled due to an insufficient remaining secure memory in the secure memory area, to swap some secure memory pages belonging to the secure memory area to a non-secure memory area, that is, swap out target data stored on some secure memory pages to a regular memory.

There is a desire for a new technical solution that can achieve a faster process of swapping out secure memory pages.

### SUMMARY

One or more embodiments of this specification provide memory page management methods and apparatuses.

According to a first aspect, a memory page management method is provided. The method is performed by a computing device, the computing device includes a processor and a memory, the processor includes a memory encryption engine (MEE), and the memory includes a secure memory area. The method includes: determining a to-be-swapped-out first memory page from the secure memory area; determining a second memory page from the memory, where the second memory page is located outside the secure memory area; encrypting, based on a physical address of the second memory page by using the MEE, target data stored on the first memory page, to obtain a target ciphertext, and writing the target ciphertext on the second memory page; and releasing the first memory page and locking the second memory page, so that the target data is allowed to swap only from the second memory page into the secure memory area.

In some possible implementations, the method further includes: in response to a page fault occurring when a secure application allowed to access the target data requests to access the target data, determining, from the memory, the second memory page that is used to store the target data; determining a third memory page from the secure memory area; decrypting, based on the physical address of the second memory page by using the MEE, the target ciphertext written on the second memory page, to obtain the target data, and storing the target data on the third memory page; and updating, based on the third memory page, a page table corresponding to the secure application.

In some possible implementations, the method further includes: clearing a cache line corresponding to the second memory page in a cache of the processor after the second memory page is determined from the memory.

In some possible implementations, the secure memory area belongs to a hardware-based TEE.

According to a second aspect, a memory page management apparatus is provided, deployed in a computing device. The computing device includes a processor and a memory, the processor includes an MEE, and the memory includes a secure memory area. The apparatus includes a paging drive module and a secure paging module. The paging drive module is configured to determine a to-be-swapped-out first memory page from the secure memory area. The paging drive module is further configured to determine a second memory page from the memory. The second memory page is located outside the secure memory area. The secure paging module is configured to encrypt, based on a physical address of the second memory page by using the MEE, target data stored on the first memory page, to obtain a target ciphertext, and write the target ciphertext on the second memory page. The paging drive module is configured to release the first memory page and lock the second memory page, so that the target data is allowed to swap only from the second memory page into the secure memory area.

In some possible implementations, the paging drive module is further configured to: in response to a page fault occurring when a secure application allowed to access the target data requests to access the target data, determine, from the memory, the second memory page that is used to store the target data; the paging drive module is further configured to determine a third memory page from the secure memory area; the secure paging module is further configured to decrypt, based on the physical address of the second memory page by using the MEE, the target ciphertext written on the second memory page, to obtain the target data, and store the target data on the third memory page; and the paging drive module is further configured to update, based on the third memory page, a page table corresponding to the secure application.

In some possible implementations, the secure paging module is further configured to clear a cache line corresponding to the second memory page in a cache of the processor after the second memory page is determined from the memory.

In some possible implementations, the secure memory area belongs to a hardware-based TEE.

According to a third aspect, a computing device is provided, including a memory and a processor. The processor includes a processing core and a memory encryption engine. The memory includes a secure memory area. The memory stores executable code/instructions located outside the secure memory area. When the processing core of the processor executes the executable code/instructions, the method in the first aspect is implemented.

According to a fourth aspect, a computer-readable storage medium is provided, storing a computer program/instructions. When the computer program/instructions are executed in a computing device, the computing device implements the method in the first aspect.

According to the methods and apparatuses provided in one or more embodiments of this specification, after determining a to-be-swapped-out first memory page from the secure memory area, the computing device can determine a second memory page from a regular memory outside the secure memory area. Then, the computing device encrypts target data stored on the first memory page based on a physical address of the second memory page by using the MEE, to obtain a target ciphertext, and writes the target ciphertext on the second memory page. Further, the computing device releases the first memory page and locks the second memory page, so that the target data is allowed to swap only from the second memory page into the secure memory area. As such, in a process of swapping out the secure memory page that belongs to the secure memory area, the computing device reuses the MEE in the processor to encrypt the target data stored on the secure memory page, so that the secure memory page can be swapped out more quickly.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this application, and a person of ordinary skill in the art can still derive other drawings from these accompanying drawings without creative efforts.

FIG. 1 is a schematic structural diagram illustrating a computing device that supports a hardware-based TEE, according to an example;

FIG. 2 is a first flowchart illustrating a memory page management method, according to one or more embodiments of this specification;

FIG. 3 is a second flowchart illustrating a memory page management method, according to one or more embodiments of this specification; and

FIG. 4 is a schematic structural diagram illustrating a memory page management apparatus, according to one or more embodiments of this specification.

### DESCRIPTION OF EMBODIMENTS

The non-limiting embodiments provided in this specification are described below in detail with reference to the accompanying drawings.

Currently, the industry pays great attention to solutions about the TEE technology. Almost all mainstream chip and software alliances have their own independent TEE solutions, for example, hardware-based TEEs such as Intel Software Guard Extensions (SGX) and ARM TrustZone. The TEE can act as a black box so that even an operating system layer cannot peep into code or data in the TEE, and only an interface predetermined in the code can be used to perform an operation on the code or the data. In terms of efficiency, due to the black box feature of the TEE, operations in the TEE are performed on plaintext data, and are not complex cryptographic operations in homomorphic encryption, so that there is almost no loss of efficiency in a computing process.

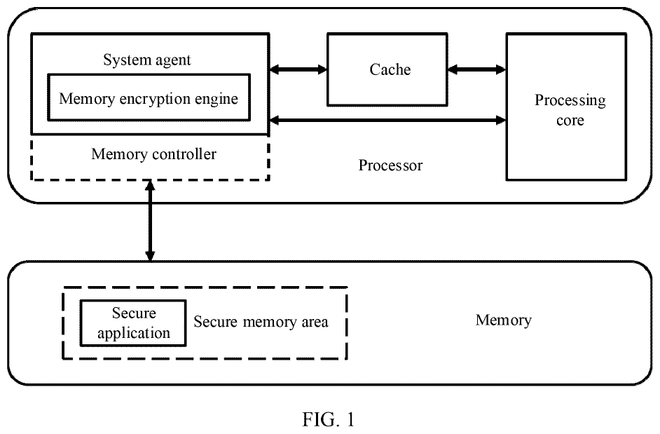

FIG. 1 is a schematic structural diagram illustrating a computing device that supports a hardware-based TEE, according to an example. As shown in FIG. 1, the computing device can include a processor and a memory. The processor includes one or more processing cores. The processing core includes but is not limited to a prefetching logic configured to extract instructions, a decoding logic configured to decode instructions, an execution logic configured to execute instructions, and the like. The processor can further include a cache configured to cache instructions and/or data, for example, may include but is not limited to a plurality of levels of caches such as L1, L2, and LLC. In addition, the processor may further include a system agent configured with an MEE. Functions of the MEE are described below in detail.

The computing device can further include another functional module, for example, a memory controller configured to support access of the processor to the memory. The memory controller may be coupled to the system agent including the MEE, or may be independent of the processor and the memory.

In a hardware-based TEE solution, a secure memory area needs to be reserved in the memory of the computing device. For example, a predetermined quantity of physical memory pages need to be reserved as the secure memory area. The following uses a secure memory area of the Intel SGX technology as an example for description: The computing device can create an enclave based on the SGX technology as a TEE for executing a specific application (secure application). The computing device can allocate, in the memory by using a processor instruction newly added to the processor, a partial area as an enclave page cache (EPC) for the enclave to reside. The memory area corresponding to the EPC is a secure memory/a secure memory area belonging to the TEE.

The MEE in the processor is configured to encrypt and decrypt data exchanged between the processor and the secure memory area. When data (code and data in the enclave) related to the secure application go from the processor to the secure memory area, the data can be encrypted by the MEE inside the processor to obtain a corresponding ciphertext, and the ciphertext can be written into the secure memory area by using the memory controller. Only the MEE can decrypt the ciphertext in the secure memory area. As such, a security boundary of the enclave includes only itself and the processor, neither privileged software nor unprivileged software can access the enclave, and even an operating system administrator and a virtual machine monitor (VMM) (or referred to as a hypervisor) cannot affect the code or the data in the enclave.

During running of the computing device, a memory paging mechanism may be enabled due to an insufficient available physical memory in the secure memory area. Different from a paging process of a regular memory page, to ensure security of data stored in the secure memory area, before a secure memory page that belongs to the secure memory area is swapped out, target data stored on the secure memory page needs to be encrypted to obtain a target ciphertext. In addition, a nonce for ensuring freshness and/or a message authentication code (MAC) for verifying integrity or the like may be generated. Then, the target ciphertext is stored on a regular memory page outside the secure memory area. Understandably, a corresponding decryption operation needs to be performed before the target ciphertext is swapped from the regular memory page into a secure memory page. In a process of executing the paging mechanism on the secure memory page, data are generally encrypted and decrypted by using software, which takes a long time.

The embodiments of this specification provide at least memory page management methods and apparatuses. A computing device that performs the methods includes a processor and a memory, the processor includes an MEE, and the memory includes a secure memory area. After determining a to-be-swapped-out first memory page from the secure memory area, the computing device can determine a second memory page from a regular memory outside the secure memory area. Then, the computing device encrypts target data stored on the first memory page based on a physical address of the second memory page by using the MEE, to obtain a target ciphertext, and writes the target ciphertext on the second memory page. Further, the computing device releases the first memory page and locks the second memory page, so that the target data is allowed to swap only from the second memory page into the secure memory area. As such, in a process of swapping out the secure memory page that belongs to the secure memory area, the computing device reuses the MEE in the processor to encrypt the target data stored on the secure memory page, so that the secure memory page can be swapped out more quickly, to facilitate more efficient running of a secure application running relying on the secure memory page.

The following describes, in detail with reference to the computing device in the example of FIG. 1, the technical solutions provided in the embodiments of this specification.

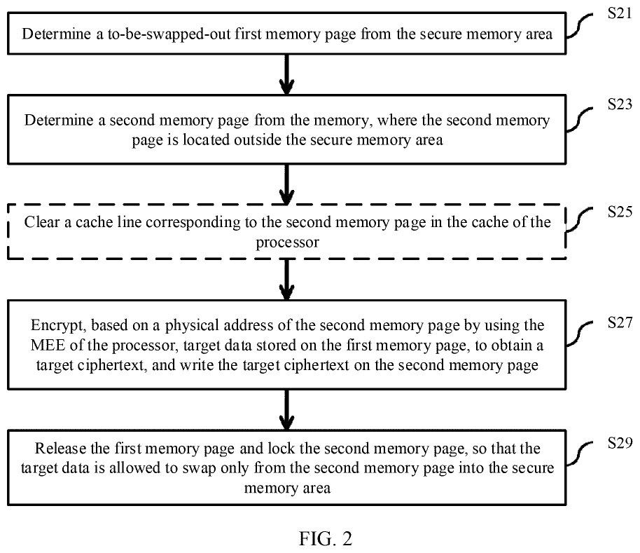

FIG. 2 is a first flowchart illustrating a memory page management method, according to one or more embodiments of this specification. The method can be performed by a computing device. The computing device includes a processor and a memory, the processor includes an MEE, the memory includes a secure memory area, the secure memory area belongs to a hardware-based TEE, and the processor can further include one or more processing cores. The method illustrates a process of swapping out a secure memory page that belongs to the secure memory area.

As shown in FIG. 2, the method can include but is not limited to some or all of the following step S21 to step S29.

Step S21: Determine a to-be-swapped-out first memory page from the secure memory area.

An operating system (OS) deployed in the computing device can be configured with a paging drive module. The paging drive module can monitor use of the memory, for example, use of the secure memory area. When the paging drive module detects an insufficient available physical memory in the secure memory area, the paging drive module can trigger a paging process on a secure memory page, and determine, based on a preconfigured decision rule such as an access frequency and/or an access time, a to-be-swapped-out first memory page from a plurality of secure memory pages that belong to the secure memory area. In terms of hardware, the processor of the computing device can execute, by using the processing core of the processor, some instructions corresponding to the paging drive module, so that the computing device implements step S21.

Step S23: Determine a second memory page from the memory, where the second memory page is located outside the secure memory area.

For example, the paging drive module can further monitor use of a regular memory area in the memory, in addition to the secure memory area. After the paging drive module decides the to-be-swapped-out first memory page, a second memory page can be subsequently determined from the regular memory area. In terms of hardware, the processor of the computing device can execute, by using the processing core of the processor, some instructions corresponding to the paging drive module, so that the computing device implements step S23.

When the second memory page is an idle memory page, that is, no related data is stored at a physical memory address of the second memory page, the following step S27 can be directly performed. When the second memory page is not an idle memory page, for example, service data that can be accessed by an application outside the TEE is stored on the second memory page, the following step S25 and step S27 can be sequentially performed.

Step S25: Clear a cache line corresponding to the second memory page in a cache of the processor.

The OS or virtual machine monitor deployed in the computing device can be configured with a secure paging module. The paging drive module can provide physical memory addresses of the first memory page and the second memory page to the secure paging module, so that the secure paging module clears the cache line corresponding to the second memory page in the cache of the processor based on the physical address of the second memory page, to ensure consistency between the physical address of the second memory page and data corresponding to the second memory page in the cache of the processor, thereby avoiding coexistence of two different copies, such as plaintext data and a target ciphertext, corresponding to the same physical memory address in the cache of the processor in a subsequent process. In terms of hardware, the processor of the computing device can execute, by using the processing core of the processor, some instructions corresponding to the secure paging module, so that the computing device implements step S25.

Step S27: Encrypt, based on the physical address of the second memory page by using the MEE of the processor, target data stored on the first memory page, to obtain a target ciphertext, and write the target ciphertext on the second memory page.

The secure paging module can provide a first page management request to the MEE, where the first page management request includes at least the physical memory addresses of the first memory page and the second memory page, and can further include indication information indicating that a page management operation that the MEE needs to perform is swapping out a secure memory page, to trigger the MEE to implement the function described in step S27. In terms of hardware, the processor of the computing device can execute, by using the processing core of the computing device, some instructions corresponding to the secure paging module, so that the processing core provides the first page management request to the MEE, to trigger the MEE to perform a corresponding page management operation.

As described above, the MEE is mainly configured to encrypt and decrypt data exchanged between the processor and the secure memory area. When data related to a secure application go from the processor to the secure memory area, the MEE encrypts the data to obtain a corresponding ciphertext and writes the ciphertext into the secure memory area by using a memory controller. In addition, when the MEE encrypts and decrypts data, a physical memory address of a secure memory page corresponding to the to-be-processed data is generally selected as input. Therefore, understandably, in step S27, in response to the first page management request, the MEE can read, from the secure memory area based on the physical address of the first memory page by using the memory controller, a first ciphertext of the target data stored on the first memory page, and decrypt the first ciphertext based on the physical address of the first memory page to obtain the target data; and then encrypt the target data based on the physical address of the second memory page to obtain the target ciphertext, and write the target ciphertext corresponding to the target data on the second memory page based on the physical address of the second memory page by using the memory controller.

In some possible implementations, the computing device can further generate, by using the secure paging module, a nonce for ensuring freshness of the target data and/or a MAC for verifying integrity of the target data and/or the target ciphertext.

Step S29: Release the first memory page and lock the second memory page, so that the target data is allowed to swap only from the second memory page into the secure memory area.

The paging drive module can update a page table corresponding to a secure application allowed to access the first memory page, and clear the first ciphertext of the target data stored on the first memory page, to complete release of the first memory page. For example, the page table includes one or more page entries, and one of the page entries includes a mapping relationship between a virtual memory page corresponding to the target data and the first memory page. The secure application initiates, by using the virtual memory page, access to the target data stored by using the first memory page. For example, the paging drive module can delete the page entry corresponding to the first memory page from the page table, or set the page entry corresponding to the first memory page to invalid, to complete update of the related page table.

The paging drive module can lock the second memory page so that the target ciphertext corresponding to the target data is fixed at the physical address of the second memory page until the target ciphertext in the second memory page is swapped into the secure memory area. After the paging drive module locks the second memory page, the OS deployed in the computing device can prohibit swapping out the second memory page to a swapping space of a disk and performing page migration on the second memory page. Alternatively, the OS deployed in the computing device allows the second memory page to be swapped out to the swapping space of the disk, and when the target ciphertext swapped out to the swapping space is swapped back into the regular memory area, the target ciphertext is only allowed to be swapped to the physical address of the second memory page, while swapping to another memory page in the regular memory area is prohibited.

In terms of hardware, the processor of the computing device can execute, by using the processing core of the processor, some instructions corresponding to the paging drive module, so that the computing device implements step S29.

When the secure application allowed to access the target data requests to access the target data that has been swapped out of the secure memory area, because the first memory page that is originally used to store the target data in the secure memory area is released, a page fault occurs on the computing device. In this case, the target data needs to be swapped back into the secure memory area. Therefore, the computing device can further maintain a correspondence between the target data and the second memory page. For example, the paging drive module maintains a correspondence between the virtual memory page corresponding to the target data and the second memory page, so that when the secure application requests to access the target data in a subsequent process, the paging drive module can swap the target data back into the secure memory area based on the correspondence.

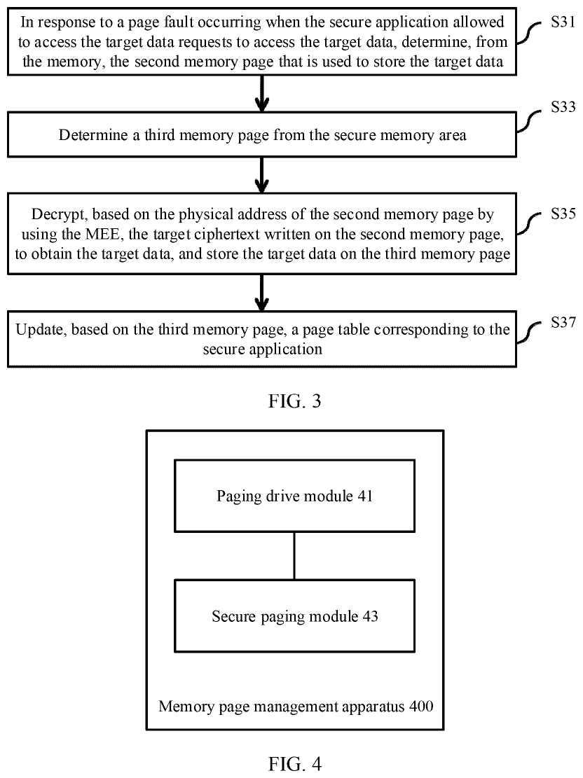

With reference to FIG. 3, a process of swapping the target data outside the secure memory area into the secure memory area can include but is not limited to some or all of the following step S31 to step S37.

Step S31: In response to the page fault occurring when the secure application allowed to access the target data requests to access the target data, determine, from the memory, the second memory page that is used to store the target data.

For example, the secure application can initiate access to the target data by using the virtual memory page corresponding to the target data. Because the page entry corresponding to the virtual memory page in the page table of the secure application is deleted or invalid, the page fault occurs. The paging drive module can process the page fault, and determine, based on the correspondence maintained by the paging drive module between the virtual memory page and the second memory page, that a memory page used to store the target data is the second memory page in the regular memory space.

Step S33: Determine a third memory page from the secure memory area.

The paging drive module can determine an idle third memory page from the secure memory area.

In terms of hardware, the processor of the computing device can execute, by using the processing core of the processor, some instructions corresponding to the paging drive module, so that the computing device implements step S31 and step S33.

Step S35: Decrypt, based on the physical address of the second memory page by using the MEE, the target ciphertext written on the second memory page, to obtain the target data, and store the target data on the third memory page.

The paging drive module can provide physical memory addresses of the second memory page and the third memory page to the secure paging module. The secure paging module can provide a second page management request to the MEE, where the second page management request includes at least the physical memory addresses of the second memory page and the third memory page, and can further include indication information indicating that a page management operation that the MEE needs to perform is swapping the secure memory page into the secure memory area, to trigger the MEE to complete the function described in step S35. In terms of hardware, the processor of the computing device can execute, by using the processing core of the computing device, some instructions corresponding to the secure paging module, so that the processing core provides the second page management request to the MEE, to trigger the MEE to perform a corresponding page management operation.

Corresponding to step S27, in response to the second page management request, the MEE can read the target ciphertext of the target data that has been written on the second memory page from the regular memory outside the secure memory area based on the physical address of the second memory page by using the memory controller, and decrypt the target ciphertext based on the physical address of the second memory page to obtain the target data; and then encrypt the target data based on the physical address of the third memory page to obtain a second ciphertext, and write the second ciphertext on the third memory page based on the physical address of the third memory page by using the memory controller.

In some possible implementations, the computing device can further verify freshness of the target data based on a corresponding nonce by using the secure paging module, to avoid a playback attack; and/or verify integrity of the target data and/or the target ciphertext based on a corresponding MAC by using the secure paging module. Understandably, when the nonce verification fails or the MAC verification fails, it can indicate that there may be an intruder initiating a playback attack or maliciously changing the target ciphertext stored on the second memory page, which can be processed by a corresponding technical means.

Step S37: Update, based on the third memory page, the page table corresponding to the secure application.

The paging drive module can add or update a valid page entry in the page corresponding to the secure application, and the page entry includes a correspondence between the virtual memory page and a third memory page for supporting access of the secure application to the target data. As such, for a request for accessing the target data that is initiated by the secure application by using the virtual memory page corresponding to the target data, the third memory page used to store the target data can be found based on a related page entry in the updated page table, to specifically access the target data stored by using the third memory page.

After swapping the target data into the secure memory, the computing device can further correspondingly release the second memory page that is previously used to store the target data. For example, after completing step S35 by using the MEE, the secure drive module can return, to the paging drive module, a response message indicating that the paging operation is successfully completed, to trigger the paging drive module to perform step S37, and delete the target ciphertext from the regular memory area based on the physical memory address of the second memory page, to complete release of the second memory page.

In the method embodiments above, the method steps implemented by the computing device are described with reference to the paging drive module and the secure paging module. However, understandably, in a process of implementing the method steps above, the computing device may not rely on the paging drive module or the secure paging module, for example, may rely on another software module.

Based on the same concept as the method embodiments above, one or more embodiments of this specification further provide a memory page management apparatus 400, deployed in a computing device. The computing device includes a processor and a memory, the processor includes an MEE, and the memory includes a secure memory area. The apparatus 400 includes a paging drive module 41 and a secure paging module 43. The paging drive module 41 is configured to determine a to-be-swapped-out first memory page from the secure memory area. The paging drive module 41 is further configured to determine a second memory page from the memory. The second memory page is located outside the secure memory area. The secure paging module 43 is configured to encrypt, based on a physical address of the second memory page by using the MEE, target data stored on the first memory page, to obtain a target ciphertext, and write the target ciphertext on the second memory page. The paging drive module 41 is configured to release the first memory page and lock the second memory page, so that the target data is allowed to swap only from the second memory page into the secure memory area.

In some possible implementations, the paging drive module 41 is further configured to: in response to a page fault occurring when a secure application allowed to access the target data requests to access the target data, determine, from the memory, the second memory page that is used to store the target data; the paging drive module 41 is further configured to determine a third memory page from the secure memory area; the secure paging module 43 is further configured to decrypt, based on the physical address of the second memory page by using the MEE, the target ciphertext written on the second memory page, to obtain the target data, and store the target data on the third memory page; and the paging drive module 41 is further configured to update, based on the third memory page, a page table corresponding to the secure application.

In some possible implementations, the secure paging module 43 is further configured to clear a cache line corresponding to the second memory page in a cache of the processor after the second memory page is determined from the memory.

In some possible implementations, the secure memory area belongs to a hardware-based TEE.

A person skilled in the art should be aware that in the one or more examples above, functions described in this specification can be implemented by hardware, software, firmware, or any combination thereof. When the functions are implemented by software, computer programs corresponding to these functions can be stored in a computer-readable medium or transmitted as one or more instructions/code in the computer-readable medium, so that when the computer programs corresponding to these functions are executed by a computer, the method in any one of the embodiments of this specification is implemented by the computer.

One or more embodiments of this specification further provide a computer-readable storage medium, storing a computer program/instructions. When the computer program/instructions are executed in a computing device, the memory page management method provided in any one of the embodiments of this specification is implemented.

One or more embodiments of this specification further provide a computing device, including a memory and a processor. The processor includes a processing core and an MEE. The memory includes a secure memory area. The memory stores executable code/instructions located outside the secure memory area. When the processing core of the processor executes the executable code/instructions, the memory page management method provided in any one of the embodiments of this specification is implemented.

The embodiments of this specification are all described in a progressive way. For same or similar parts of the embodiments, mutual references can be made to the embodiments. Each embodiment focuses on a difference from other embodiments. In particular, the apparatus embodiments are basically similar to the method embodiments, and therefore are described briefly. For related parts, references can be made to related descriptions in the method embodiments.

Specific embodiments of this specification are described above. Other embodiments fall within the scope of the appended claims. In some cases, the actions or steps described in the claims can be performed in an order different from the order in the embodiments and the desired results can still be achieved. In addition, the process depicted in the accompanying drawings does not necessarily need a particular order or a sequential order to achieve the desired results. In some implementations, multi-tasking and concurrent processing are feasible or may be advantageous.

The specific implementations described above further describe the purposes, technical solutions, and beneficial effects of this application. Understandably, the descriptions above are merely specific implementations of this application and are not intended to limit the protection scope of this application. Any modification, equivalent replacement, or improvement made based on the technical solutions of this application shall fall within the protection scope of this application.

What is claimed is:

1. A computer-implemented method for memory page management, comprising:
determining a to-be-swapped-out first memory page from a secure memory area of a memory;
determining a second memory page from the memory, wherein the second memory page is located outside the secure memory area;
encrypting, based on a physical address of the second memory page by using a memory encryption engine (MEE) of a processor to obtain a target ciphertext, target data stored on the to-be-swapped-out first memory page;
writing the target ciphertext on the second memory page;
releasing the to-be-swapped-out first memory page; and
locking the second memory page, so that the target data is allowed to swap only from the second memory page into the secure memory area.

2. The computer-implemented method of claim 1, comprising:
in response to a page fault occurring when a secure application, allowed to access the target data, requests access to the target data:
determining, from the memory, the second memory page that is used to store the target data.

3. The computer-implemented method of claim 2, comprising:
determining a third memory page from the secure memory area.

4. The computer-implemented method of claim 3, comprising:
decrypting, based on the physical address of the second memory page by using the MEE, the target ciphertext written on the second memory page, to obtain the target data, and storing the target data on the third memory page.

5. The computer-implemented method of claim 4, comprising:
updating, based on the third memory page, a page table corresponding to the secure application.

6. The computer-implemented method of claim 1, comprising:
clearing a cache line corresponding to the second memory page in a cache of the processor after the second memory page is determined from the memory.

7. The computer-implemented method of claim 1, wherein the secure memory area belongs to a hardware-based trusted execution environment (TEE).

8. A non-transitory, computer-readable medium storing one or more instructions executable by a computer system to perform one or more operations for memory page management, comprising:
determining a to-be-swapped-out first memory page from a secure memory area of a memory;
determining a second memory page from the memory, wherein the second memory page is located outside the secure memory area;
encrypting, based on a physical address of the second memory page by using a memory encryption engine (MEE) of a processor to obtain a target ciphertext, target data stored on the to-be-swapped-out first memory page;
writing the target ciphertext on the second memory page;
releasing the to-be-swapped-out first memory page; and
locking the second memory page, so that the target data is allowed to swap only from the second memory page into the secure memory area.

9. The non-transitory, computer-readable medium of claim 8, comprising:
in response to a page fault occurring when a secure application, allowed to access the target data, requests access to the target data:
determining, from the memory, the second memory page that is used to store the target data.

10. The non-transitory, computer-readable medium of claim 9, comprising:
determining a third memory page from the secure memory area.

11. The non-transitory, computer-readable medium of claim 10, comprising:
decrypting, based on the physical address of the second memory page by using the MEE, the target ciphertext written on the second memory page, to obtain the target data, and storing the target data on the third memory page.

12. The non-transitory, computer-readable medium of claim 11, comprising:
updating, based on the third memory page, a page table corresponding to the secure application.

13. The non-transitory, computer-readable medium of claim 8, comprising:
clearing a cache line corresponding to the second memory page in a cache of the processor after the second memory page is determined from the memory.

14. The non-transitory, computer-readable medium of claim 8, wherein the secure memory area belongs to a hardware-based trusted execution environment (TEE).

15. A computer-implemented system for memory page management, comprising:
one or more computers; and
one or more computer memory devices interoperably coupled with the one or more computers and having tangible, non-transitory, machine-readable media storing one or more instructions that, when executed by the one or more computers, perform one or more operations, comprising:
determining a to-be-swapped-out first memory page from a secure memory area of the one or more computer memory devices;
determining a second memory page from the one or more computer memory devices, wherein the second memory page is located outside the secure memory area;
encrypting, based on a physical address of the second memory page by using a memory encryption engine (MEE) of the one or more computers to obtain a target ciphertext, target data stored on the to-be-swapped-out first memory page;
writing the target ciphertext on the second memory page;
releasing the to-be-swapped-out first memory page; and
locking the second memory page, so that the target data is allowed to swap only from the second memory page into the secure memory area.

16. The computer-implemented system of claim 15, comprising:
in response to a page fault occurring when a secure application, allowed to access the target data, requests access to the target data:
determining, from the one or more computer memory devices, the second memory page that is used to store the target data.

17. The computer-implemented system of claim 16, comprising:
determining a third memory page from the secure memory area.

18. The computer-implemented system of claim 17, comprising:
decrypting, based on the physical address of the second memory page by using the MEE, the target ciphertext written on the second memory page, to obtain the target data, and storing the target data on the third memory page.

19. The computer-implemented system of claim 18, comprising:
updating, based on the third memory page, a page table corresponding to the secure application.

20. The computer-implemented system of claim 15, comprising:
clearing a cache line corresponding to the second memory page in a cache of the one or more computers after the second memory page is determined from the one or more computer memory devices.
